(19) United States
(12) Patent Application Publication
(10) Pub. No.: US 2023/0226733 A1
(43) Pub. Date: Jul. 20, 2023

(54) WEBS

(71) Applicant: 3M INNOVATIVE PROPERTIES COMPANY, St. Paul, MN (US)

(72) Inventors: Ronald W. Ausen, St. Paul, MN (US); William J. Kopecky, Hudson, WI (US)

(21) Appl. No.: 18/000,527

(22) PCT Filed: May 5, 2021
(86) PCT No.: PCT/IB2021/053796

§ 371 Date: Dec. 2, 2022

Related U.S. Application Data
(60) Provisional application No. 63/035,970, filed on Jun. 8, 2020.

(51) Int. Cl. B29C 48/00; B29C 48/11; B29C 48/345

(52) U.S. Cl. CPC B29C 48/0015; B29C 48/11; B29C 48/345

(57) ABSTRACT

A web. The web includes an array of discrete polymeric tubes, wherein the cross-section of each polymeric tube has a non-circular shape; wherein adjacent polymeric tubes has a bond region; wherein polymeric tubes are hollow polymeric tubes; wherein adjacent polymeric tubes are connected at bond regions; and wherein the web is a continuous web.

### BACKGROUND

Methods for making webs and continuous extruded tubing are known in the art. Today, many types of tubes and hoses are made with polymer materials (e.g., polyethylene) that are extruded using an extruder and extrusion die.

Relatively smaller sized tubing, such as capillary tubing and hollow fiber, require precision dies for consistent tube shape. This is because the flow rate of material is very dependent upon the resistance within the die. Small changes in the cavity size have significant effects on the resultant extruded part. Thus, for uniformity of flow, passageway resistance within the die is critical to the formation of uniform tubing.

Hollow fiber and capillary tubing can provide mass transfer if the tubing wall is permeable, and thermal transfer if the tubing wall is thermally conductive. It can provide padding and cushioning with elastomeric materials. The small size of the tubing can result in difficulty in managing multiple tubes at one time.

Connected webs of small sized tubing can be useful for padding and cushioning of fragile elements. The small tubes provide an air barrier for compression. Small tubing webs can be useful for heat transfer applications (e.g., battery, electronic, and mechanical apparatus cooling). The small tubing size enables close contact with the cooling media to the apparatus to be cooled. Small tubing webs may also be used as spacer layers to minimize weight.

There exists a need for alterative tube configurations and methods to make them.

### SUMMARY

In one aspect, the present disclosure describes a web comprising, an array of discrete polymeric tubes, wherein the cross-section of each polymeric tube has a non-circular shape; wherein adjacent polymeric tubes has a bond region; wherein polymeric tubes are hollow polymeric tubes; wherein adjacent polymeric tubes are connected at bond regions; and wherein the web is a continuous web.

In another aspect, the present disclosure herein describes a method of making the web of claims , the method comprising: providing an extrusion die comprising a plurality of shims positioned adjacent to one another, the shims together defining at least a first cavity, and a second cavity, and a dispensing surface, wherein the dispensing surface has an array of alternating dispensing orifices, wherein the plurality of shims comprises a plurality of a repeating sequence of shims, wherein the repeating sequence comprises: shims that provide a first passageway extending from the first cavity to a first plurality of enclosed polygon shaped orifices, and also that provide a second passageway extending from a second cavity to a second plurality of orifices located within the enclosed polygon orifice area; and wherein the adjacent orifice regions of adjacent polygon shaped orifices are approximately parallel to each other, and dispensing first polymeric tubes from the first dispensing orifices and providing an open air passageway for the second cavity and the second dispensing orifices.

In another aspect, the present disclosure herein describes a method of making the web of claims, the method comprising: providing an extrusion die comprising an array of orifices positioned close to one another such that material dispensed from the orifices welds together once they exit the orifices, wherein the adjacent orifice regions are approximately parallel to each other, wherein a first die cavity is connected to a plurality of enclosed polygon shaped orifices, and a second cavity is connected to a second plurality of orifices located within the enclosed polygon orifice area; and dispensing first polymeric tubes from the first dispensing orifices and providing an open air passageway for the second cavity and the second dispensing orifices.

### BRIEF DESCRIPTION OF THE DRAWINGS

FIG. 1 is a schematic cross-sectional view of an exemplary coextruded polymeric article described herein.

FIG. 2 is a schematic cross-sectional view of an exemplary die orifice pattern at the dispensing surface of the die employed in the formation of an exemplary coextruded polymeric article described herein.

FIG. 3A is a plan view of an exemplary embodiment of a shim suited to form a sequence of shims capable of forming an exemplary coextruded polymeric article, for example, as shown in the schematic cross-sectional views of FIG. 1.

FIG. 3B is an expanded region near the dispensing surface of the shim shown in FIG. 3A.

FIG. 4A is a plan view of an exemplary embodiment of a shim suited to form a sequence of shims capable of forming a coextruded polymeric article, for example, as shown in the schematic cross-sectional views of FIG. 1.

FIG. 4B is an expanded region near the dispensing surface of the shim shown in FIG. 4A.

FIG. 5A is a plan view of an exemplary embodiment of a shim suited to form a sequence of shims capable of forming a coextruded polymeric article, for example, as shown in the schematic cross-sectional views of FIG. 1.

FIG. 5B is an expanded region near the dispensing surface of the shim shown in FIG. 5A.

FIG. 6 is a plan view of an exemplary embodiment of a shim suited to form a sequence of shims capable of forming a coextruded polymeric article, for example, as shown in the schematic cross-sectional views of FIG. 1.

FIG. 7 is a perspective assembly drawing of several different exemplary sequences of shims employing the shims of FIGS. 3A, 4A, 5A, and 6 for making exemplary coextruded polymeric articles described herein, segments and protrusions in a repeating arrangement as shown in FIG. 1.

FIG. 8 is a perspective view of the some of the sequence of shims of FIG. 7, further exploded to reveal individual shims.

FIG. 9 is an exploded perspective view of an example of a mount suitable for an extrusion die composed of multiple repeats of the sequence of shims of FIG. 7.

FIG. 10 is a perspective view of the mount of FIG. 9 in a semi-assembled state.

FIG. 11 is an optical image of the Example 1 article.

FIG. 12 is and optical image of the Example 2 article.

### DETAILED DESCRIPTION

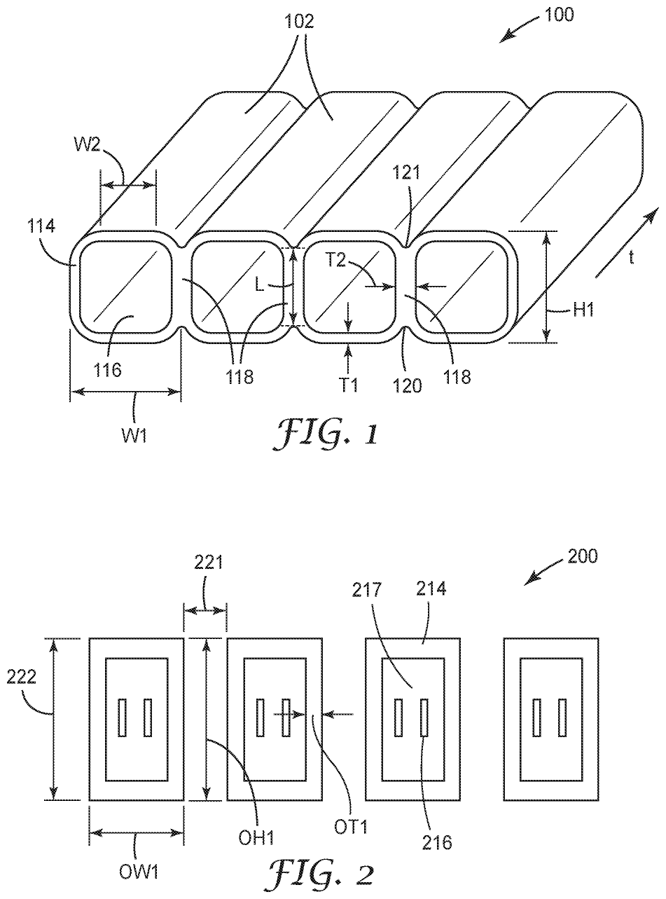

Referring to FIG. 1, exemplary web 100 comprises array of discrete polymeric tubes 102. Polymeric tubes 102 can be hollow polymeric tubes (i.e., a hollow core 116 with a sheath 114 surrounding the hollow core).

In some embodiments, the hollow cross-sectional area of the tubes with hollow cross-sectional area is greater than 50%, 60%, 70% or 80% of the area between the top and bottom surface of the web. Adjacent polymeric tubes 102 are connected at bond regions 118. The length L of bond regions 118 is more than 5% of the average diameter of polymeric tubes 102.

In general, the length L of the bond region creates a more rectilinear tubular opening of adjacent connected tubes when the bond length is longer. Rectilinear shapes with round corners, such as squircles, result in hollow cross sectional areas which have a greater portion of the area between the top and bottom surface of the web as compared to circular shapes which are bonded together at only a tangent point. Short bond lengths L create tubular shapes which are more oval in shape. These squircle shapes can also be extruded onto flat quench surfaces to create flat top or bottom segments of the squircle shape. Rectilinear shaped squircles enable larger contact area to the top and bottom planar surfaces than that of circular shaped tubes. This larger contact area can be useful for heat transport between the top or bottom surface and a cooling media inside the tubes. In some embodiments, the bond region has a length L of a range from 0.1 mm to 5 mm. In some embodiments, the thickness T2 of the bond region is substantially uniform along its length. As shown in exemplary web 100 of FIG. 1, the cross-section of polymeric tubes 102 have the same shapes.

In some other embodiments, the cross-section of polymeric tubes 102 can have different shapes. The cross-section of polymeric tubes 102 can be any suitable shapes, for example, a squircle. The polymeric tubes 102 have a tube wall thickness T1 in a range from 0.025 to 0.25 mm. Adjacent polymeric tubes have a first bond point 120 and second bond point 121, and the bond point has a radius more than 0.1 T1, 0.2 T1, 0.3 T1, 0.4 T1, or 0.5 T1. These bond points represent the beginning and ending of the bond region between adjacent tubes. As such, they are the beginning point and the end point of the bond line shown as length L in FIG. 1. The bond point with the adjacent tube walls, creates the radius at the ends of the bond length. Bond points with radiuses provide crack propagation resistance between tubes. In some embodiments the strength of the bond or weld between tubes is greater than the strength of the wall T1 of the tubes. As shown in FIG. 1, web 100 can be a continuous web. As shown in exemplary web 100 of FIG. 1, polymeric tubes 102 are within the same plane. FIG. 1 shows individual tube width W1 and individual tube height H1. Squircle shaped tubes have flat surfaces on the top and bottom surface of the web. Dimension W2 and dimension t shown in FIG. 1 can be used to determine contact area of squircle shaped tubular webs. Surface contact area as a percentage can be calculated by comparison of dimension W1 vs W2, shown in FIG. 1.

In some embodiments the contact area of the top and bottom surface of the squircle shaped web can be up to 10%, up to 25%, 50% or even up to 95% of the top or bottom planar surface area.

In some embodiments, webs described herein have a height H1 up to 5,000 (in some embodiments, up to, 2,00, 1,000, 500, or even up to 100; in a range from 100 to 5,000, 100 to 2,000, 100 to 1,000, or even 100 to 500) micrometers.

In some embodiments, the polymeric tubes have an average cross-sectional diameter in a range from 0.1 to 5 mm.

In some embodiments the thickness T2 is twice the thickness T1. In some embodiments the thickness T1 is uniform around the perimeter of the tube. In some embodiments the thickness T1 is varied to assist in formation of desired tubular shapes.

In some embodiments, at least 25 (in some embodiments, at least 30, 35, 40, 45, 50, 55, 60, 65, 70, 75, 80, 85, 90, 95, or even 100) percent by number hollow polymeric tubes each have a hollow cross-sectional area in a range from 0.1 to 10 (in some embodiments, in a range from 0.1 to 2, or even 0.1 to 5) mm².

In some embodiments, the polymer comprises a filler material (e.g., aluminum oxide, aluminum nitride, aluminum trihydrate, boron nitride, aluminum, copper, graphite, graphene, magnesium oxide, zinc oxide) to provide thermal conductivity.

In some embodiments, the array of polymeric tubes exhibits at least one of oval-shaped, or squircle-shaped cross section, openings.

In some embodiments, the polymeric tubes have a down web direction, for example t direction as shown in FIG. 1 and a cross-web direction. The polymeric tubes extends substantially in a down-web direction.

Some embodiments of webs described herein where the sheathed core of fluid (e.g., at least one of gas (e.g., air) or liquid (e.g., water, ethylene glycol, or mineral oil)) are useful, for example, for as padding and spacer materials (e.g., for personal padding and packaging applications).

In some embodiments, at least some of tubes of web described herein are filled with thermally conductive material (i.e., materials having a thermal conductivity of at least 0.5 watts per meter kelvin). Exemplary thermally conductive materials include functional particles of (e.g., aluminum oxide, aluminum nitride, aluminum trihydrate, boron nitride, aluminum, copper, graphite, graphene, magnesium oxide, zinc oxide) to provide desired thermal properties to articles described herein.

Additional information that may be useful in making and using tubes described therein, when combined with the instant disclosure, can be found in WO 2020/003065 A1 (Ausen et al.), the disclosure of which is incorporated herein by reference.

Embodiments of webs described herein can be made, for example by a method comprising: providing an extrusion die comprising a plurality of shims positioned adjacent to one another, the shims together defining at least a first cavity, a second cavity, and a third cavity, and a dispensing surface, wherein the dispensing surface has an array of alternating dispensing orifices, wherein the plurality of shims comprises a plurality of a repeating sequence of shims, wherein the repeating sequence comprises: shims that provide a fluid passageway between the first cavity to a first plurality of enclosed polygon shaped orifices, and also that provide a second passageway extending from a second cavity to a second plurality of orifices located within the enclosed polygon orifice area; and dispensing first polymeric tubes from the first dispensing orifices, and providing an open air passageway for the second cavity and the second dispensing orifices. In some embodiments, the second passageway is filled with air or gas and free of other material. In some embodiments, dispensing filler material (e.g., a fluid) from the second dispensing orifices.

Embodiments of webs described herein can be made, for example by a method comprising: providing an extrusion die comprising an array of orifices positioned close to one another such that material dispensed from the orifices welds together once they exit the orifices, wherein the adjacent orifice regions are approximately parallel to each other, wherein a first die cavity is connected to a plurality of enclosed polygon shaped orifices, and a second cavity is connected to a second plurality of orifices located within the enclosed polygon orifice area; and dispensing first polymeric tubes from the first dispensing orifices, and providing an open air passageway for the second cavity and the second dispensing orifices. The spacing between orifices is less than OW1. The length of parallel orifices of adjacent orifice regions is greater than 1 OT1, and typically greater than 2 OT1, 5 OT1, or even 10 OT1.

In some embodiments, the first dispensing orifices and the second dispensing orifices are collinear. In some embodiments, the first dispensing orifices are collinear, and the second dispensing orifices are also collinear but offset from and not collinear with the first dispensing orifices. In some embodiments the orifice thickness OT1 is uniform around the orifice shape. In some embodiments the orifice thickness OT1 is different on different sides of the orifice shape.

In some embodiments, extrusion dies described herein include a pair of end blocks for supporting the plurality of shims. In these embodiments it may be convenient for one or all of the shims to each have one or more through-holes for the passage of connectors between the pair of end blocks. Bolts disposed within such through-holes are one convenient approach for assembling the shims to the end blocks, although the ordinary artisan may perceive other alternatives for assembling the extrusion die. In some embodiments, the at least one end block has an inlet port for introduction of fluid material into one, or both, of the cavities.

In some embodiments, the shims will be assembled according to a plan that provides a repeating sequence of shims of diverse types. The repeating sequence can have diverse numbers of shims per repeat.

Exemplary passageway cross-sectional shapes include square and rectangular shapes. The shape of the passageways within, for example, a repeating sequence of shims, may be identical or different. For example, in some embodiments, the shims that provide a passageway between the first cavity and a first dispensing orifice might have a flow restriction compared to the shims that provide a conduit between the second cavity and a second dispensing orifice. The width of the distal opening within, for example, a repeating sequence of shims, may be identical or different. For example, the portion of the distal opening provided by the shims that provide a conduit between the first cavity and a first dispensing orifice could be narrower than the portion of the distal opening provided by the shims that provide a conduit between the second cavity and a second dispensing orifice.

In some embodiments, the assembled shims (conveniently bolted between the end blocks) further comprise a manifold body for supporting the shims. The manifold body has at least one (or more (e.g., two, three, four, or more)) manifold therein, the manifold having an outlet. An expansion seal (e.g., made of copper or alloys thereof) is disposed so as to seal the manifold body and the shims, such that the expansion seal defines a portion of at least one of the cavities (in some embodiments, a portion of both the first and second cavities), and such that the expansion seal allows a conduit between the manifold and the cavity.

Typically, the passageway between cavity and dispensing orifice is up to 5 mm in length. Sometimes the first array of fluid passageways has greater fluid restriction than the second array of fluid passageways.

The shims for dies described herein typically have thicknesses in the range from 50 micrometers to 125 micrometers, although thicknesses outside of this range may also be useful. Typically, the fluid passageways have thicknesses in a range from 50 micrometers to 750 micrometers, and lengths less than 5 mm (with generally a preference for smaller lengths for decreasingly smaller passageway thicknesses), although thicknesses and lengths outside of these ranges may also be useful. For large diameter fluid passageways several smaller thickness shims may be stacked together, or single shims of the desired passageway width may be used.

The shims are tightly compressed to prevent gaps between the shims and polymer leakage. For example, 12 mm (0.5 inch) diameter bolts are typically used and tightened, at the extrusion temperature, to their recommended torque rating. Also, the shims are aligned to provide uniform extrusion out the extrusion orifice, as misalignment can lead to tubes extruding at an angle out of the die which inhibits desired bonding of the net. To aid in alignment, an alignment key can be cut into the shims. Also, a vibrating table can be useful to provide a smooth surface alignment of the extrusion tip.

FIG. 2 is a schematic cross-sectional view of an exemplary die orifice pattern at the dispensing slot of the die employed in the formation of an exemplary coextruded polymeric article described herein. Orifice plan 200 shows first orifices 214, and second orifices 216. Area 217 separates orifice 214 and 216 and helps to create the center of the tube. Orifice 214 has overall height OH1 and overall width OW1. The width of orifice 214 has dimension OT1. Orifice 216 is used to fill the tube with air. Orifice 214 is a continuous polygon orifice and creates a unitary closed tube structure. The gap 221 between orifices 214 creates a demarcation line when polymer streams merge together once they exit the extrusion orifices. The demarcation lines are created between orifices separated by a minimal amount, by spacer shims. These shims typically have thicknesses in a range from 50 to 200 micrometers. Multiple spacer shims can be used to create the desired distance between orifices 214. Distance 222 helps determine the bond length between tubes. For example, short spacing 221 between orifices 214 with long length 222 create long bond lengths between tubes. These long bond lengths enable non circular tube shapes, such as squircles, which can hold their shape with use.

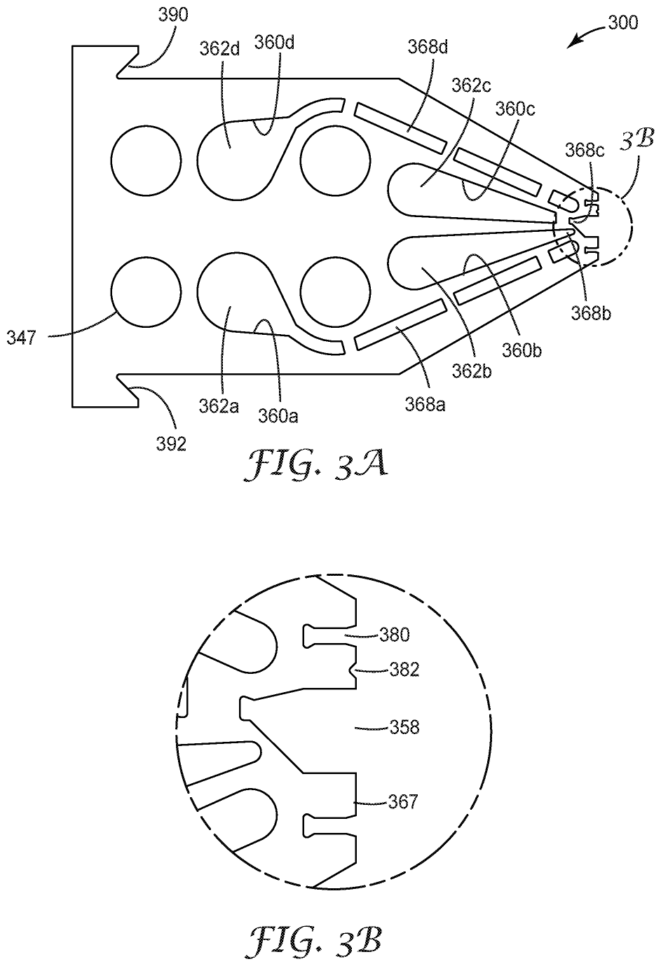

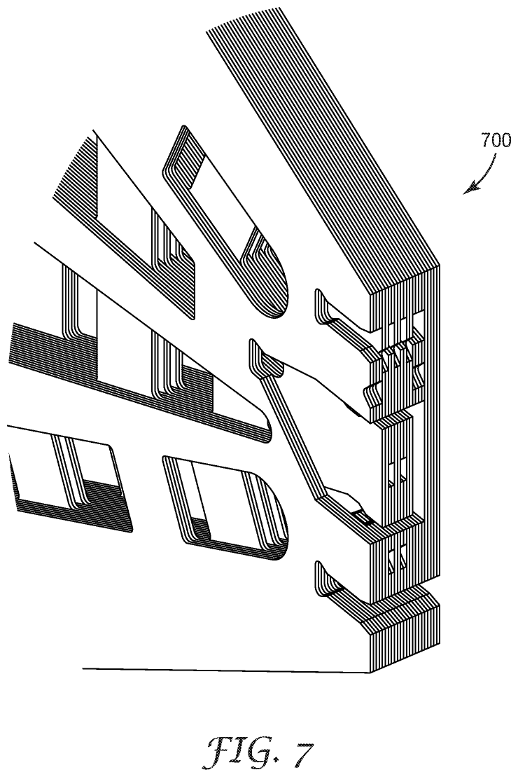

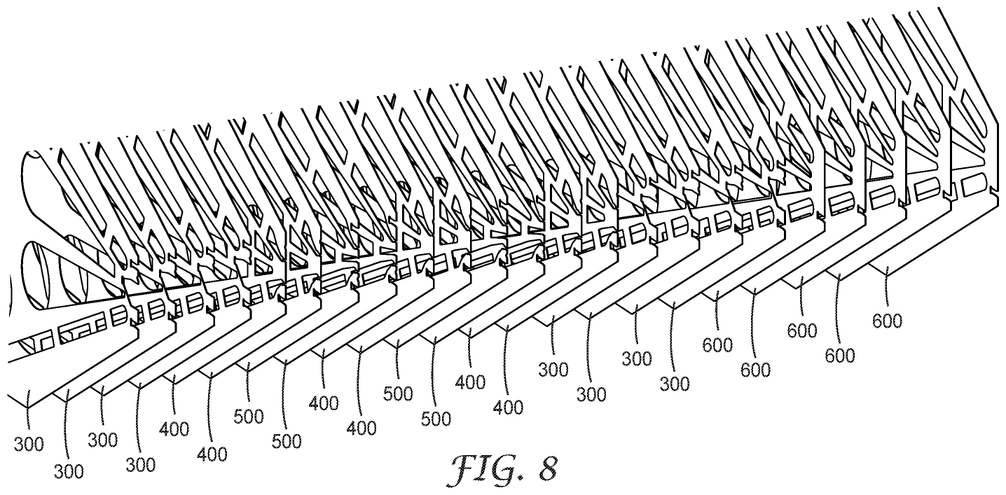

Referring now to FIGS. 3A and 3B, a plan view of shim 300 is illustrated. Shim 300 has first aperture 360a, second aperture 360b, third aperture 360c, and fourth aperture 360d. When shim 300 is assembled with others as shown in FIGS. 7 and 8, aperture 360a aids in defining first cavity 362a, aperture 360b aids in defining second cavity 362b, aperture 360c aids in defining third cavity 362c, and aperture 360d aids in defining third cavity 362d. Passageways 368a, 368b, 368c, and 368d cooperate with analogous passageways on adjacent shims to allow passage from cavities 362a, 362b, 362c, and 362d to the dispensing surfaces of the appropriate shims when the shims are assembled as shown in FIGS. 7 and 8.

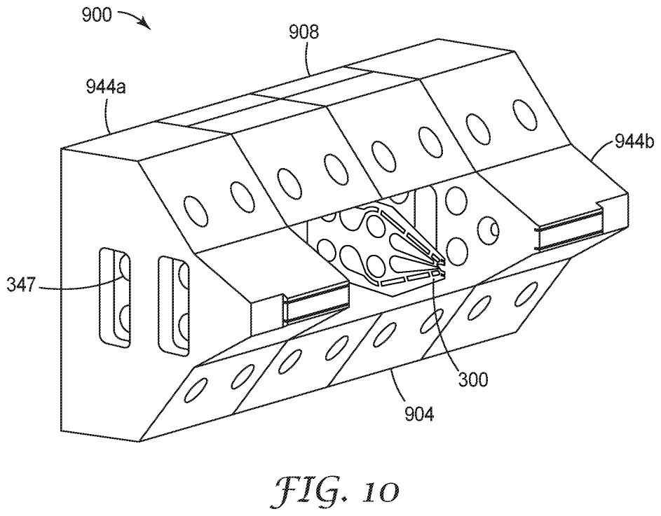

Shim 300 has several holes 347 to allow the passage of, for example, bolts, to hold shim 300 and others to be described below into an assembly. Shim 300 also has dispensing surface 367, and in this embodiment, dispensing surface 367 has indexing groove 380 which can receive an appropriately shaped key to ease assembling diverse shims into a die. The shim may also have identification notch 382 to help verify that the die has been assembled in the desired manner. This embodiment has shoulders 390 and 392 which can assist in mounting the assembled die with a mount of the type shown in FIG. 10. Shim 300 has dispensing opening 358. Dispensing opening 358 has connection to cavity 362c and provides the sidewall structure of the tube illustrated in FIG. 1.

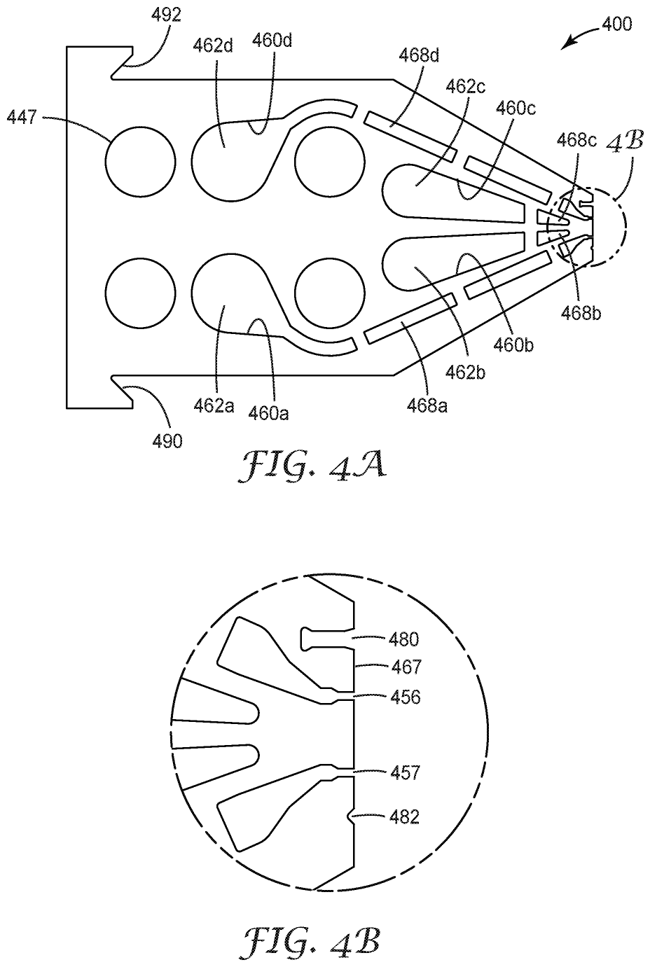

Referring now to FIGS. 4A and 4B, a plan view of shim 400 is illustrated. Shim 400 has first aperture 460a, second aperture 460b, third aperture 460c, and fourth aperture 460d. When shim 400 is assembled with others as shown in FIGS. 7 and 8, aperture 460a aids in defining first cavity 462a, aperture 460b aids in defining second cavity 462b, aperture 460c aids in defining third cavity 462c, and aperture 460d aids in defining third cavity 462d. Passageways 468a, 468b, 468c, and 468d cooperate with analogous passageways on adjacent shims to allow passage from cavities 462a, 462b, 462c, and 462d to the dispensing surfaces of the appropriate shims when the shims are assembled as shown in FIGS. 7 and 8.

Shim 400 has several holes 447 to allow the passage of, for example, bolts, to hold shim 400 and others to be described below into an assembly. Shim 400 also has dispensing surface 467, and in this embodiment, dispensing surface 467 has indexing groove 480 which can receive an appropriately shaped key to ease assembling diverse shims into a die. The shim may also have identification notch 482 to help verify that the die has been assembled in the desired manner. This embodiment has shoulders 490 and 492 which can assist in mounting the assembled die with a mount of the type shown in FIG. 10. Shim 400 has dispensing opening 456, and 457. Dispensing opening 457 has connection to cavity 462a and provides the bottom-wall structure of the tube illustrated in FIG. 1. Dispensing opening 456 has connection to cavity 462d and provides top-wall structure of the tube illustrated in FIG. 1.

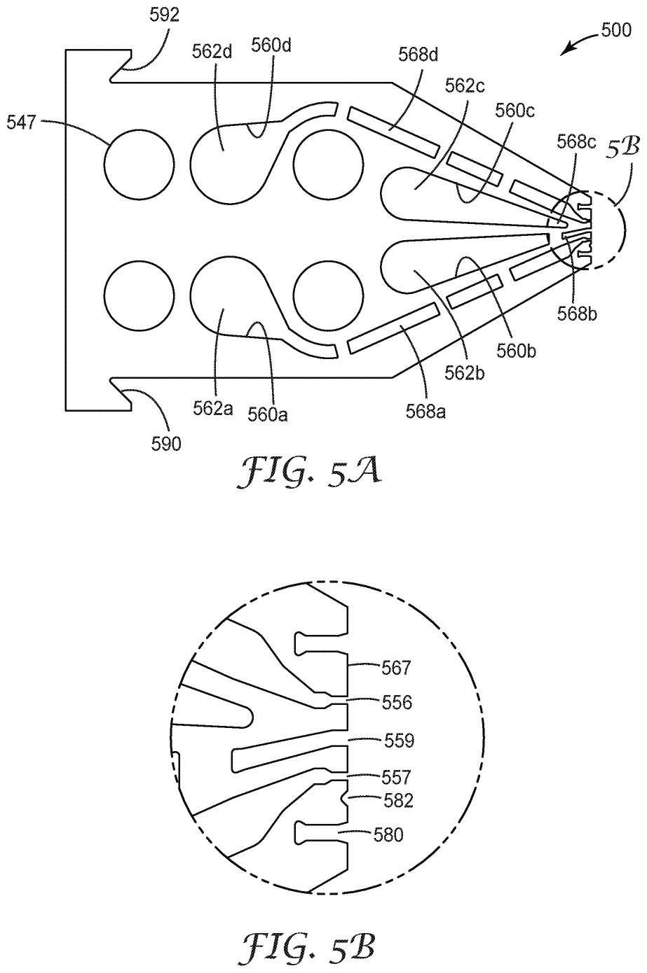

Referring now to FIGS. 5A and 5B, a plan view of shim 500 is illustrated. Shim 500 has first aperture 560a, second aperture 560b, third aperture 560c, and fourth aperture 560d. When shim 500 is assembled with others as shown in FIGS. 7 and 8, aperture 560a aids in defining first cavity 562a, aperture 560b aids in defining second cavity 562b, aperture 560c aids in defining third cavity 562c, and aperture 560d aids in defining third cavity 562d. Passageways 568a, 568b, 568c, and 568d cooperate with analogous passageways on adjacent shims to allow passage from cavities 562a, 562b, 562c, and 562d to the dispensing surfaces of the appropriate shims when the shims are assembled as shown in FIGS. 7 and 8.

Shim 500 has several holes 547 to allow the passage of, for example, bolts, to hold shim 500 and others to be described below into an assembly. Shim 500 also has dispensing surface 567, and in this embodiment, dispensing surface 567 has indexing groove 580 which can receive an appropriately shaped key to ease assembling diverse shims into a die. The shim may also have identification notch 582 to help verify that the die has been assembled in the desired manner. This embodiment has shoulders 590 and 592 which can assist in mounting the assembled die with a mount of the type shown in FIG. 10. Shim 500 has dispensing opening 556, 557, and 559. Dispensing opening 556 has connection to cavity 562d and opening 557 has connection to cavity 562a and provides the top and bottom structure of the tube illustrated in FIG. 1. Dispensing opening 559 has connection to cavity 562b and provides air inside the tube illustrated in FIG. 1.

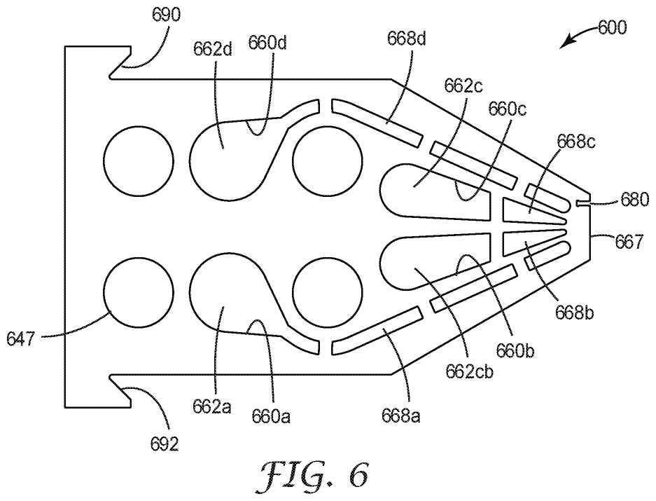

Referring now to FIG. 6, a plan view of shim 600 is illustrated. Shim 600 has first aperture 660a, second aperture 660b, third aperture 660c, and fourth aperture 660d. When shim 600 is assembled with others as shown in FIGS. 7 and 8, aperture 660a aids in defining first cavity 662a, aperture 660b aids in defining second cavity 662b, aperture 660c aids in defining third cavity 662c, and aperture 660d aids in defining third cavity 662d. Passageways 668a, 668b, 668c, and 668d cooperate with analogous passageways on adjacent shims to allow passage from cavities 662a, 662b, 662c, and 662d to the dispensing surfaces of the appropriate shims when the shims are assembled as shown in FIGS. 7 and 8.

Shim 600 has several holes 647 to allow the passage of, for example, bolts, to hold shim 600 and others to be described below into an assembly. Shim 600 also has dispensing surface 667, and in this embodiment, dispensing surface 667 has indexing groove 680 which can receive an appropriately shaped key to ease assembling diverse shims into a die. This embodiment has shoulders 690 and 692 which can assist in mounting the assembled die with a mount of the type shown in FIG. 10. Shim 600 does not have dispensing orifices. Shim 600 forms orifice walls and spacing between orifices in the dispensing surface for creation of the tube illustrated in FIG. 1.

Referring to FIG. 7, a perspective assembly drawing of a several different repeating sequences of shims, collectively 700, employing the shims of FIGS. 3, 4, 5, and 6 to produce coextruded polymeric article 100 shown in FIG. 1 is shown. It can be seen that collectively the shims form a dispensing surface shown in further detail in FIG. 2.

Referring to FIG. 8, an exploded perspective assembly drawing of a repeating sequence of shims employing the shims of FIGS. 3, 4, 5, and 6 is illustrated. In the illustrated embodiment, the repeating sequence includes, from bottom to top as the drawing is oriented, 300, 300, 300, 300, 400, 400, 500, 500, 400, 400, 500, 500, 400, 400, 300, 300, 300, 300, 600, 600, 600, 600, 600.

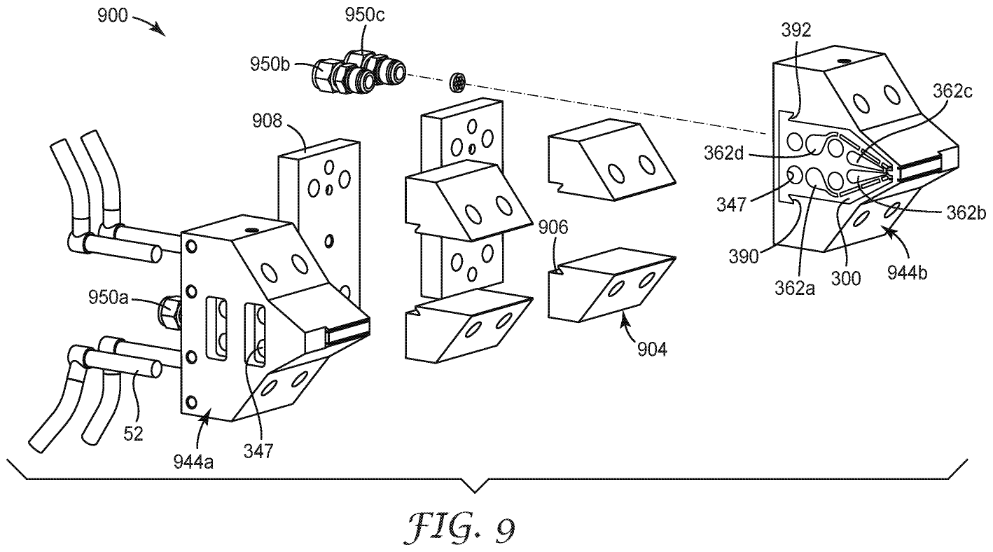

Referring to FIG. 9, an exploded perspective view of a mount 900 suitable for an extrusion die composed of multiple repeats of the repeating sequence of shims of FIG. 7 is illustrated. Mount 900 is particularly adapted to use shims 300, 400, 500, and 600 as shown in FIGS. 3-6. For visual clarity, however, only a single instance of shims is shown in FIG. 9. The multiple repeats of the repeating sequence of shims are compressed between two end blocks 944a and 944b. Conveniently, through bolts can be used to assemble the shims to end blocks 944a and 944b, passing through holes 347 in shims 300 et al.

In this embodiment, inlet fittings 950a, 950b, 950c, and a fourth fitting not shown provide a flow path for four streams of molten polymer through end blocks 944a and 944b to cavities 362a, 362b, 362c, and 362d. Compression blocks 904 have notch 906 that conveniently engages the shoulders on shims (e.g., 390 and 392) on 300. When mount 900 is completely assembled, compression blocks 904 are attached by, for example, machine bolts to backplates 908. Holes are conveniently provided in the assembly for the insertion of cartridge heaters 52.

Referring to FIG. 10, a perspective view of the mount 900 of FIG. 9 is illustrated in a partially assembled state. A few shims, for example, 300 are in their assembled positions to show how they fit within mount 900, but most of the shims that would make up an assembled die have been omitted for visual clarity.

The shim stack, and die mount, as shown in FIGS. 9 and 10 is assembled with shims and compressed together. Extruders for polymers and air or fluid supply are connected to the die for extrusion of tube web. Generation of tube webs is formed with polymer extrusion from the polygonal shapes, with air or gas pressure regulated within the tubes to maintain the internal tubular cavity. The size (same or different) of the tube be adjusted, for example, by the composition of the extruded polymers, velocity of the extruded tubes, and/or the orifice design (e.g., cross sectional area (e.g., height and/or width of the orifices)). The amount of internal tube pressure will determine the amount of tube swell as it exits the die and contribute to determine the final size of the tubes and also the bond length L. The air or liquid used to maintain the inside of the tubular cavity is regulated with a controllable pressure or flow rate.

Typically, the polymeric tubes are extruded in the direction of gravity. In some embodiments, it is desirable to extrude the tubes horizontally, especially when the extrusion orifices of the first and second polymer are not collinear with each other. Squircle shaped tubes can be extruded horizontally onto a smooth quench roll. Optionally a gaped nip may be used to quench the top and bottom of the tube equally and to assist in creating parallel top and bottom wall sections of the squircle shaped tubes. Tubes may be extruded horizontally or vertically onto a quench roll without a gaped nip. In this case, round top squircle shaped tubes can be created. The bond length L may be varied to create a variety of tube shapes. It may be desired to create semi round tubes, whereby there is a long bond length L on one side of the tube, and a point bond with a short bond length L on the other side. It may be desired to create nonplanar webs where bonds between tubes are not directly across from each other. Bonds may be generated at 90 degrees around the circumference for example to create semi circular structures with non planar webs.

In practicing methods described herein, the polymeric materials might be solidified simply by cooling. This can be conveniently accomplished passively by ambient air, or actively by, for example, quenching the extruded first and second polymeric materials on a chilled surface (e.g., a chilled roll). In some embodiments, the first and/or second polymeric materials are low molecular weight polymers that need to be cross-linked to be solidified, which can be done, for example, by electromagnetic or particle radiation. In some embodiments, it is desirable to maximize the time to quenching to increase the weld strength.

Suitable polymeric materials for extrusion from dies described herein, methods described herein, and for composite layers described herein include thermoplastic resins comprising polyolefins (e.g., polypropylene and polyethylene), polyvinyl chloride, polystyrene, nylons, polyesters (e.g., polyethylene terephthalate) and copolymers and blends thereof. Suitable polymeric materials for extrusion from dies described herein, methods described herein, and for composite layers described herein also include elastomeric materials (e.g., ABA block copolymers, polyurethanes, polyolefin elastomers, polyurethane elastomers, metallocene polyolefin elastomers, polyamide elastomers, ethylene vinyl acetate elastomers, and polyester elastomers) Other desirable materials include, for example, styrene-acrylonitrile, cellulose acetate butyrate, cellulose acetate propionate, cellulose triacetate, polyether sulfone, polymethyl methacrylate, polyurethane, polyester, polycarbonate, polyvinyl chloride, polystyrene, polyethylene naphthalate, copolymers or blends based on naphthalene dicarboxylic acids, polyolefins, polyimides, mixtures and/or combinations thereof. Exemplary release materials for extrusion from dies described herein, methods described herein, and for composite layers described herein include silicone-grafted polyolefins such as those described in U.S. Pat. Nos. 6,465,107 (Kelly) and 3,471,588 (Kanner et al.), silicone block copolymers such as those described in PCT Pub. No. WO96039349, published Dec. 12, 1996, and low density polyolefin materials such as those described in U.S. Pat. Nos. 6,228,449 (Meyer), 6,348,249 (Meyer), and 5,948,517 (Meyer), the disclosures of which are incorporated herein by reference.

In some embodiments, the first and second polymers are independently a thermoplastic (e.g., adhesives, nylons, polyesters, polyolefins, polyurethanes, elastomers (e.g., styrenic block copolymers), and blends thereof).

In some embodiments, the plurality of tubes includes alternating first and second polymeric tubes.

In some embodiments, the tubes provide thermal cooling, whereby the tubes transport cooling or heating fluid and provide heat transport to surfaces above and or below the web surface. The squircle shape maximizes the internal tubular area between the top and bottom surface of the web for use with fluid transport media. The shape of the squircle, height and width, can be adjusted via the length of the bond L as shown in FIG. 1 with dimensions W1 and H1.

The Squircle shape enables high contact area with the top and bottom surface of the web structure. FIG. 1 shows contact area with the multiplication of dimension W2 and length t for each tubular component. Structures with flat top and bottom surfaces enable high contact area as a percentage of the total top or bottom surface area. Squricle shaped tubes that are narrow in cross sectional length and long in the height direction can be created with extrusion die orifices with closely spaced rectilinear shapes that are long in the height direction, short in the cross direction, and spaced closely together to create long bond lengths L.

In some embodiments, it may be desirable for the tube to comprise a fluid (e.g., at least one of gas (e.g., air), liquid (e.g., water, ethylene glycol, or mineral oil), or viscous fluid (e.g., thermal grease)) in the core may be desirable, for example, for thermal transport in thermal interface articles used to control the temperature of and/or dissipate heat for electronic components and batteries or mechanical devices. Exemplary gasses include air and inert gases. Exemplary liquids include water and ethylene glycol and mineral oils. In some embodiments, it may be desirable for the tube to comprise an endothermic material (e.g., wax) in the core which absorbs heat when it melts and releases heat when it solidifies. Such embodiments may be useful, for example, for electronic components and batteries or mechanical devices. It is typically necessary to add a filler material as the web is extruded to prevent collapse of the hollow tube. It may be desired to first fill the hollow tube with air with subsequent replacement with a suitable filler material. This can be injected after the web has quenched. In some embodiments the liquid may be used to transport thermal energy through the hollow tube in the machine direction of the hollow tube. In some embodiments, the liquid may be used to transport thermal energy across the thickness direction of the hollow tube from a first face to a second face of the web. In this way the core material provides thermal transport with flexibility to conform to irregular shapes. In this case, higher viscosity materials may be used such as thermal greases.

In some embodiments, the first polymeric tubes and the second polymeric tubes are both formed with a hollow core arrangement. In particular, the first polymeric tubes may have a sheath of polymeric material different than the second polymeric tubes.

In some embodiments, polymeric materials used to make webs described herein may comprise a colorant (e.g., pigment and/or dye) for functional (e.g., optical effects) and/or aesthetic purposes (e.g., each has different color/shade). Suitable colorants are those known in the art for use in various polymeric materials.

Exemplary colors imparted by the colorant include white, black, red, pink, orange, yellow, green, aqua, purple, and blue. In some embodiments, it is desirable level to have a certain degree of opacity for one or more of the polymeric materials. The amount of colorant(s) to be used in specific embodiments can be readily determined by those skilled in the (e.g., to achieve desired color, tone, opacity, transmissivity, etc.). If desired, the polymeric materials may be formulated to have the same or different colors. When colored tubes are of a relatively fine (e.g., less than 50 micrometers) diameter, the appearance of the web may have a shimmer reminiscent of silk.

### EXAMPLES

### Example 1

A web, as depicted in FIG. 1, was prepared as follows. A co-extrusion die as depicted in FIGS. 9 and 10 and assembled with a multi-shim repeating pattern of extrusion orifices as illustrated in FIGS. 7 and 8, was prepared. The thickness of the shims in the repeat sequence was 4 mils (0.102 mm). These shims were formed from stainless steel, with perforations cut by wire electrical discharge machining (wire EDM). The shims were stacked in a repeating sequence 300, 300, 300, 300, 400, 400, 500, 500, 400, 400, 500, 500, 400, 400, 300, 300, 300, 300, 600, 600, 600, 600, 600. The designs for shims 300, 400, 500, and 600 are shown in FIGS. 3-6, respectively. Note that shims 300 and 500 can be oriented in two possible configurations. For this Example, shim 300 was oriented to utilize a first center cavity, and shim 500 was oriented to utilize a second center cavity. This second center cavity provided air to the center of the tube. This configuration created a repeating length of 92 mils (2.34 mm), with cavities, passageways, and orifices, such that the first extruder fed a center cavity and passageways for the top, bottom and sides of the tubular channels. The second center cavity was connected to low pressure air to fill the center of the tube structures. The outside third and fourth cavities were not used. In this configuration backfilling of these cavities likely resulted because of a connection between the first center cavity and the third and fourth cavity. This result is not ideal but was accepted for expediency in the case of this Example. The shims were assembled with the other parts shown to create a die approximately 8 cm in width. The extrusion orifices were aligned in a collinear arrangement, alternating between tubular channels and connecting film sections, resulting in a dispensing surface at the die exit as depicted in FIG. 2.

The inlet fitting for the first center cavity was connected to a conventional single-screw extruder via a neck tube. The extruder feeding the cavity of the die was fed polyethylene (obtained under the trade designation “ELITE 5230” from Dow Chemical, Midland, Mich.) dry blended with 2% color concentrate (obtained under the trade designation “PP23642905” from Clariant, Minneapolis, Minn.). A separate cavity was used to supply compressed air into the tubular channels. A valve and regulator was used to limit the airflow to the die cavity. The airflow was further regulated with an in-line connected tube which ended in a container of water, the end of the tube submerged 5 mm below water, to maintain a constant pressure inside the cavity.

The melt was extruded vertically into an extrusion quench takeaway apparatus. The quench roll was a smooth temperature-controlled chrome plated 20 cm diameter steel roll. The quench nip temperature was controlled with internal water flow. The web path wrapped 180 degrees around the chrome steel roll and then proceeded to a windup roll.

Other process conditions are listed below:
Flow rate for the first extruder 1.5 kg/hr.
Extrusion temperature 218° C.
Quench roll temperature 10° C.
Quench takeaway speed 0.5 m/min.

An optical microscope was used to measure web dimensions:
Total caliper (thickness): 1.75 mm
Tube wall thickness: 0.11 mm
Bond thickness: 0.21 mm
Bond length: 1.05 mm
Tube open area: 2.6 mm2
Tube perimeter: 5.7 mm
Bond end radius: 0.05 mm

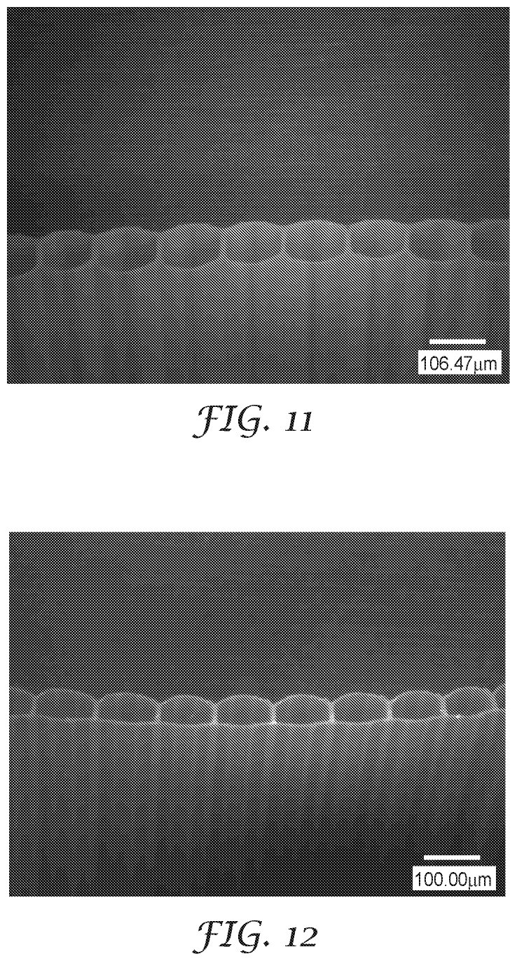

A micrograph of the web in a perspective view showing cross section is shown in FIG. 11.

### Example 2

Example 2 was made the same as Example 1, except that the takeaway speed was 1.5 m per minute.

An optical microscope was used to measure web dimensions:
Total caliper (thickness): 0.775 mm
Tube wall thickness: 0.045 mm
Bond thickness: 0.102 mm
Bond length: 0.47 mm
Tube open area: 0.7 mm²
Tube perimeter: 3.4 mm
Bond end radius: 0.06 mm

A micrograph of the web in a perspective view showing cross section is shown in FIG. 12.

For further details, see PCT Pat. Pub. No. WO2020/003066 A1 (Kuduva Raman Thanumoorthy, et al.), the disclosure of which is incorporated herein by reference in its entirety.

Foreseeable modifications and alterations of this disclosure will be apparent to those skilled in the art without departing from the scope and spirit of this invention. This invention should not be restricted to the embodiments that are set forth in this application for illustrative purposes.

1. A web comprising, an array of discrete polymeric tubes, wherein the cross-section of at least some of the polymeric tubes have a rectilinear shape with rounded corners;
wherein adjacent polymeric tubes has a bond region;
wherein the polymeric tubes are hollow polymeric tubes;
wherein adjacent polymeric tubes are connected at bond regions; and
wherein the web is a continuous web.

2. The web of claim 1, wherein the cross-section of at least some of the polymeric tubes has the shape of a squircle.

3. The web of claim 1, wherein the bond region has a length greater than 5 percent of average diameter of the discrete polymeric tubes.

4. The web of claim 1, the tubes have a tube wall thickness T1 in a range from 0.025 to 0.25 mm.

5. The web of claim 1, wherein the bond region has a thickness substantially uniform along its length.

6. The web of claim 1, wherein the bond region has a length of a range from 0.1 mm to 5 mm.

7. The web of claim 1, wherein adjacent polymeric tubes has a bond point and the bond point has a radius more than 0.5 T1.

8. The web of claim 1, wherein the tubes are within the same plane.

9. The web of claim 1, wherein the web has a thickness up to 5 millimeters.

10. The web of claim 1, wherein the tubes have an average cross-sectional diameter in a range from 0.1 to 5 mm.

11. The web of claim 1, wherein the tubes have a hollow cross-sectional area in a range from 0.1 to 10 mm².

12. A method of making the web of claim 1, the method comprising:
providing an extrusion die comprising a plurality of shims positioned adjacent to one another, the shims together defining at least a first cavity, and a second cavity, and a dispensing surface, wherein the dispensing surface has an array of alternating dispensing orifices, wherein the plurality of shims comprises a plurality of a repeating sequence of shims, wherein the repeating sequence comprises: shims that provide a first passageway extending from the first cavity to a first plurality of enclosed polygon shaped orifices, and also that provide a second passageway extending from a second cavity to a second plurality of orifices located within the enclosed polygon shaped orifices; and wherein the adjacent orifice regions of adjacent polygon shaped orifices are approximately parallel to each other, and
dispensing first polymeric tubes from the first dispensing orifices and providing an open air passageway for the second cavity and the second dispensing orifices.

13. The method of claim 12, wherein the second passageway is filled with gas

14. A method of making the web of claim 1, the method comprising:
providing an extrusion die comprising an array of orifices positioned close to one another such that material dispensed from the orifices welds together once they exit the orifices,
wherein the adjacent orifice regions are approximately parallel to each other,
wherein a first die cavity is connected to a plurality of enclosed polygon shaped orifices, and a second cavity is connected to a second plurality of orifices located within the enclosed polygon shaped orifices area; and
dispensing first polymeric tubes from the first dispensing orifices and providing an open air passageway for the second cavity and the second dispensing orifices.

15. The method of claim 14, wherein the spacing between orifices is less than the overall width of the orifices, OW1.
